(19) United States
(12) Patent Application Publication
(10) Pub. No.: US 2015/0120497 A1
(43) Pub. Date: Apr. 30, 2015

(54) PRIVATE STORE PROVIDING SPECIAL PRICING AND OTHER RESTRICTIONS BASED UPON SPECIFIC GROUPS AND PRODUCTS

(71) Applicant: Digital River, Inc., Minnetonka, MN (US)

(72) Inventors: Michael J. CHUMA, Cologne, MN (US); Bryan Robert ZIEGLER, St. Louis Park, MN (US)

(21) Appl. No.: 14/530,416

(22) Filed: Oct. 31, 2014

Related U.S. Application Data
(60) Provisional application No. 61/898,089, filed on Oct. 31, 2013.

(51) Int. Cl. G06Q 30/06

(52) U.S. Cl. CPC G06Q 30/0633
USPC 705/26.8

(57) ABSTRACT

The disclosed invention may be used to provide special pricing and restrictions on specific products for a selected group or groups of shoppers. The present disclosure provides methods that a seller can define which products want to make available and at what price, and how a seller want to control access for shoppers. An exemplary system implementation also includes how many shoppers can purchase during a given time period. This current invention may be implemented at online distributed ecommerce environment. Further the present invention would be commonly used in employee purchase plans, special discounts for partners, education pricing for academic entities, discounts plan for employee friends and family members, loyalty program of fan clubs plans and or a like.

### RELATED APPLICATIONS

The present application is claims the benefit of U.S. Provisional Patent Application No. 61/898,089 filed on 31 Oct. 2013, the contents of which are incorporated in their entirety. A claim of priority is made.

### FIELD OF THE INVENTION

The present invention relates to ecommerce, and more particularly, relates to cloud based commerce platform providing ecommerce sales functionality allowing for special pricing and other restrictions on specific products for a selected group or groups of online shoppers in a distributed computing environment over the network, such as the Internet or other type of network. Its related technical fields are software development and electronic commerce.

### BACKGROUND

While ecommerce growth and opportunity is undeniable, the online ecommerce market has been widely changed. In conventional online market, a seller would simply set-up an online store and sell their products without any further demands of excessive additional software development for the online store. However, owing to the current diversity of online customer segmentation, a seller must consider how to keep his customers in such competitive changing ecommerce environment by finding new ways to sell directly to different customer segments. With conventional online store development methods, if a seller needs to build a new online store for new market segments, it would newly create and implement all online store webpages even though the new stores have only minor differences from the original online store. Such repeated efforts of rebuilding online stores would waste seller's resources including development time, duplicated storage space, etc.

The presently disclosed system and methods provide a solution to such issues and offer other features and improvement over the prior art. The present disclosure includes application engines for purchase planning, product availability, pricing and access controls to support targeted customer segments. By implementing the disclosed system and methods, a seller may easily tap into new market segments. A seller can avoid channel conflicts with minimum advertised price and may find a way to liquidate overstocked items or items nearing end of life. A seller may also strengthen partner relationships by offering discounts to their employees, can use purchase limits to prevent abuse of a discounted product price, and can quickly setup new offerings without wasting excessive resources.

### SUMMARY OF THE INVENTION

The present invention, known as a Private Store or Purchase Plan, allows a client to create special priced products for a set of explicitly known shoppers or a known segment of shoppers (for example partners, students or employees). This invention is used to provide dynamic customization of public stores product assortment, pricing, promotional offers, purchase restrictions and presentation triggered by certain identifiers associated with a shopper. These identifiers may include email address, email domain, generic identifier (access code), referring URL, referring IP address, and an invitations. A storeowner or a seller is able to define which products are to be made available and at what price, available promotional offers, customized presentation and how they will be accessed by shoppers in different segments. The quantity of an item a shopper may purchase over time can also be controlled by Private Store. Limits can optionally be re-set when a given window passes.

Benefits of the Private Store include, but not limited to strengthening partner relationships by offering discounts to their employees, using purchase limits to prevent abuse of a discounted product price, and fast setup of new private store offerings to reach new segments of shoppers. This functionality would most commonly be implemented in discounts for employees, special discounts for partners, education pricing, friends and family members, and loyalty, VIP, or fan stores.

Private Stores can create a targeted and custom shopping experience by tailoring design controls over look and feel, customization of the layout of one or more pages to maximize close ratios for targeted segments of shoppers. Additionally, the private store can be co-branded to reinforce a partner relationship throughout the sales process on the storefront.

### BRIEF DESCRIPTION OF THE DRAWINGS

FIG. 1 is a block diagram which illustrates an architecture for implementing Private Store according to an exemplary embodiment;

FIG. 2 is a block diagram which illustrates a hierarchy of Private Stores and plans assigned according to an exemplary embodiment;

FIG. 3 is a block diagram which illustrates a conceptual model for plural Private Stores and microstores;

FIG. 4 is a block diagram which illustrates a flow chart to setup Private Store to implement Private Store according to an exemplary embodiment;

FIG. 5 illustrates filtering identifiers to implement access rules for granting, only according to an exemplary embodiment;

FIG. 6 illustrates a shopping order flow of Friends and Family plan for implementing by email invitation only according to an exemplary embodiment.

### DETAILED DESCRIPTION

The presently disclosed system and method embraces the benefits of an efficient model for targeting product assortment, pricing, promotional offers and overall shopping experience to known segments of customers. By using the presently disclosed system and method, a seller can find a new ways to sell directly to different customer segments, avoid potential channel conflicts, protect discounted pricing and product availability to approved customers and control to market-focused merchandising and sales.

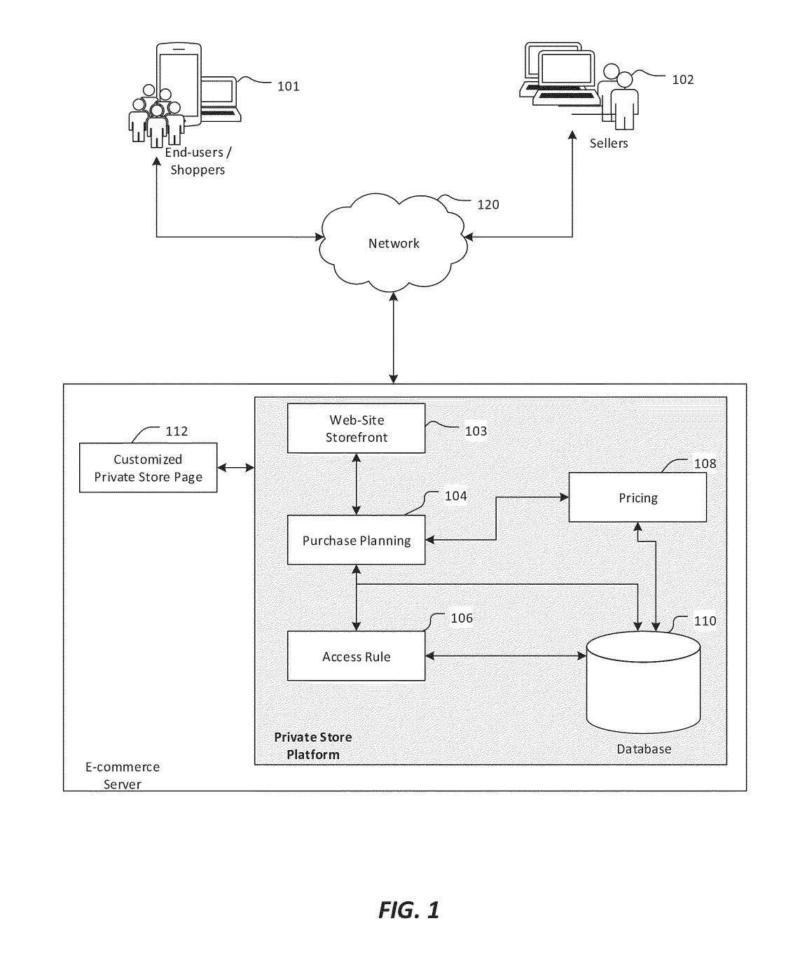

Referring to FIG. 1, the present invention has six major components: purchase restrictions/timeframes, access rule engine, product assortment, presentation configuration, promotional offer availability and pricing module. The components may implemented in modules like purchase planning 104, access rule 106 and pricing module 108. Those modules may implemented in separate modules or integrated modules depending on functional efficiency of online stores. To implement the present invention, a seller may need to enroll such services for enabling Private Store embodiment. In a seller's online store web site 103, a seller 102 can create a Private Store by using those major modules. The aforementioned modules are implemented in a hierarchical taxonomy that allows the seller to customize the least amount of information needed to launch a new shopping experience for a known targeted segment of shoppers. The intersection of all the settings from the major modules above on each level of the taxonomical tree create the resulting shopping experience for the approved shopper. Items with the most specificity will overwrite those with less specificity. For example a price may be set or discounted at any point in the hierarchy. The embodiment in figure one implementation has the price set on the public store, private store, a group within the private store, the product within the group and the microstore. Each one is more specific than its predecessor. If a price is set on a microstore for a product it will have the most specificity since it is the lowest point in the taxonomical tree. This value will be displayed to the shopper since it will be the most applicable for them. The system starts broad and gets more specific as it works its way down the tree. It can match one specific shopper and generate a targeted shopping experience for that particular shopper.

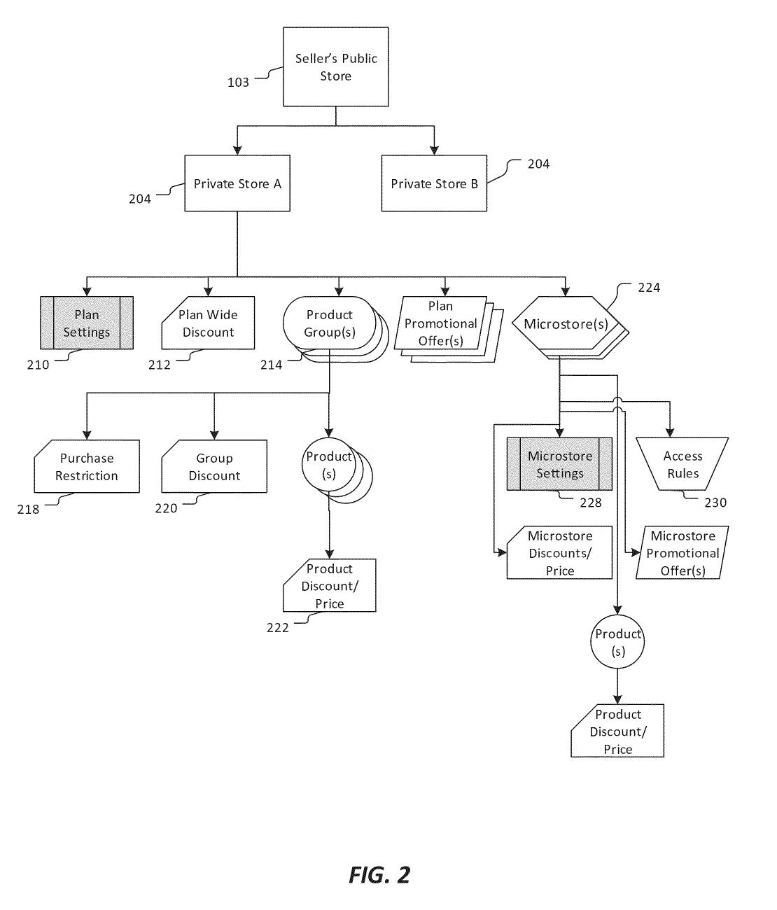

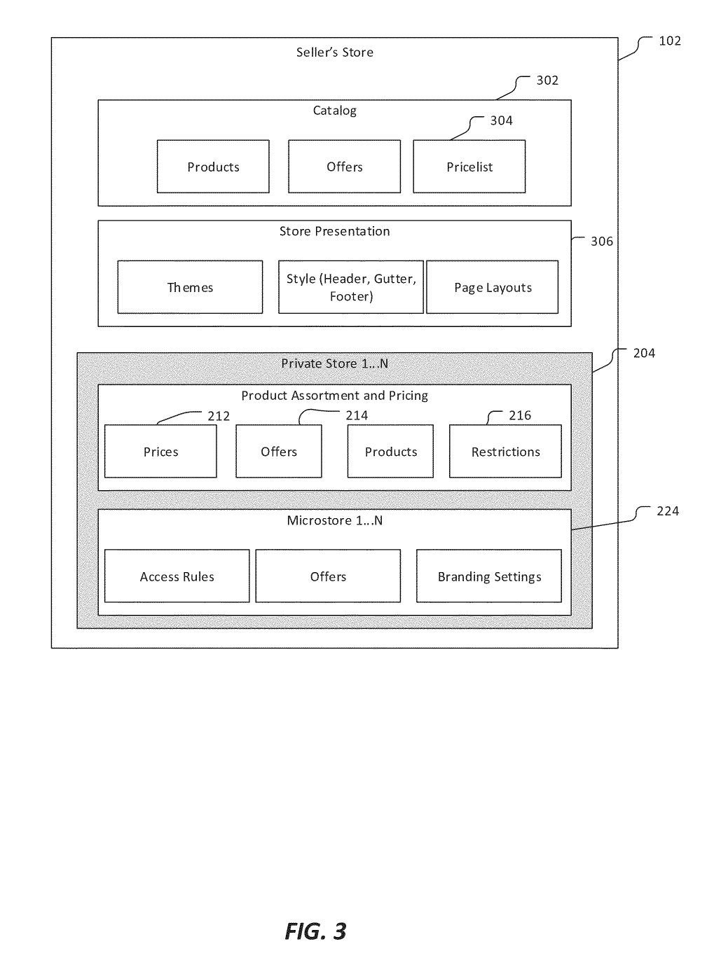

These modules are communicate interactively with 110 database which stores features such as store theme and style, customer profile, product profile, price list and other related elements for implementing a Private Store. After setting a Private Store by a seller, shoppers 101 may access to general storefront web site 103 or may directly access to customized Private Store 112. The access may connected through network 120. FIG. 2 shows an exemplary hierarchy model of Private Stores and the FIG. 3 shows an exemplary block diagram of Private Stores.

Throughout the specification and claims, the following terms take the meanings explicitly associated herein, unless the context clearly dictates otherwise.

The term “seller” refers to the business entity who is typically the original source of the finished good which is ultimately sold to the end-customer. In this document, seller may be a subscriber of the Private Store service provider. The term “Private Store manager” refers to one who may create or deploy a Private Store. The terms “Private Store manager” and “plan manager” are used interchangeably in this document. The term “a seller” and “a store owner” are also used interchangeably. The term “minimum advertised price” is an agreement between suppliers and retailers stipulating the lowest price at which an item is allowed to be advertised. The term “access rule” is a method for accessing a Private Store. The term “PIN (private identification number)” is a numeric password shared between a user and a system that can be used to authenticate the user to the system. The term “authentication” is the process of confirming an identity for system use. The term “authorization is the function to specify access rights to system resources.

### Hierarchical Data Model

Private Stores allows for quick setup of targeted shopping experiences for known shoppers or segments of shoppers through the use of a hierarchical data model. In the embodiment in FIG. 2, the public store is at the top of the tree 103. The public store has a set of products, prices, promotional offers and presentation configurations. This public store can have many private stores. A private store can modify these and more aspects of the public store. Only items that the seller wants to modify need to added or changed at the Private Store level everything that is not modified can inherit the configurations or values from the public store if the seller chooses to. Examples of private stores might be Bronze, Silver and Gold Partner Stores and Full Time and Contractor Employee stores. Each of these Private Stores may have an overrides from the public store configuration for items, such as, product assortment, pricing, promotional offers, purchase restrictions and shopping experience. In the embodiment in FIG. 2, the next level down are microstores. A microstore further segments the private store. In the Gold private store mentioned above could have multiple microstores. Each micorstore may represent one or more partners. For example one microstore may be for Partner XYZ and another for Partner ABC. Each of these microstores may have an override from the Private Store configuration for items, such as product assortment, pricing, promotional offers, purchase restrictions and shopping experience. In this embodiment, the microstore is where the known shoppers or known segments of shoppers may be defined.

### Product Groups and Purchase Restrictions

Private Stores provide an additional mechanism for segmenting products called product groups 214. A Private Store can have one or more product groups. A product is a structure that is a dynamic (rule based) or an explicit list of products. By grouping products together a discount can be applied to all to products that match the rule defined on the group or the explicit list of products. Additionally, purchase restrictions 218 can be applied to group. These purchase restrictions will be evaluated at checkout time to determine if the shopper has is under any threshold before they are allowed to purchase. Examples of possible product groups might be Game Consoles, Video Games, and Accessories. Game Consoles, might be 5% of due to lower margins, where accessories might be discounted at 30% due higher margins.

Each product group can provide a set of purchase restrictions that will be evaluated at checkout time to see if the shopper is under any limits that might have optionally been set. Quantity restrictions can be set at a product level or for the entire group. For example the shopper might be able to only buy one game console in the game console group or one of each game in the group examples above.

Each group can also define when the restrictions reset. Restrictions can be time, calendar or rolling window based.

### Access Rules

Private Stores can define access rules to grant a known shopper or segment of shoppers' access to a specific shopping experience. In the embodiment in present invention, access is controlled by the microstore in the hierarchical data model. Each microstore can have multiple access rules that could be trigger to grant access.

In the one of the embodiments, in the following access rules are implemented, however, the any piece of data on a shopper or incoming request could be used to grant access. The embodiment uses Email Whitelist, Email Domain, Referring URL, Referring IP Address, Email Invitation and Generic Identifier.

Each access rule may be use independently or they may be combined together to create a stricter access rule. For example a shopper could get access from just the domain of their email address or something more complex, like they must originate from a certain IP address and have a specific referring URL and an allowed domain.

Each access rule can also specify multiple values. For example the domain access rule could be one domain or a list of many domains.

Access rules are evaluated when a shopper triggers and action on the storefront. This action may be any of the following but not limited to. Logging in, triggering a specific URL (Browse, Click, Redirect, etc), Applying for Access, etc. Once they trigger the access rules engine, each rule is evaluated to see if they should be granted access by examining data that is available on the shopper or the request. Example pieces of data might be IP Address, Referring URL, Domain, Email Address, Invitation Link, Access Code, Shopper Account, etc.

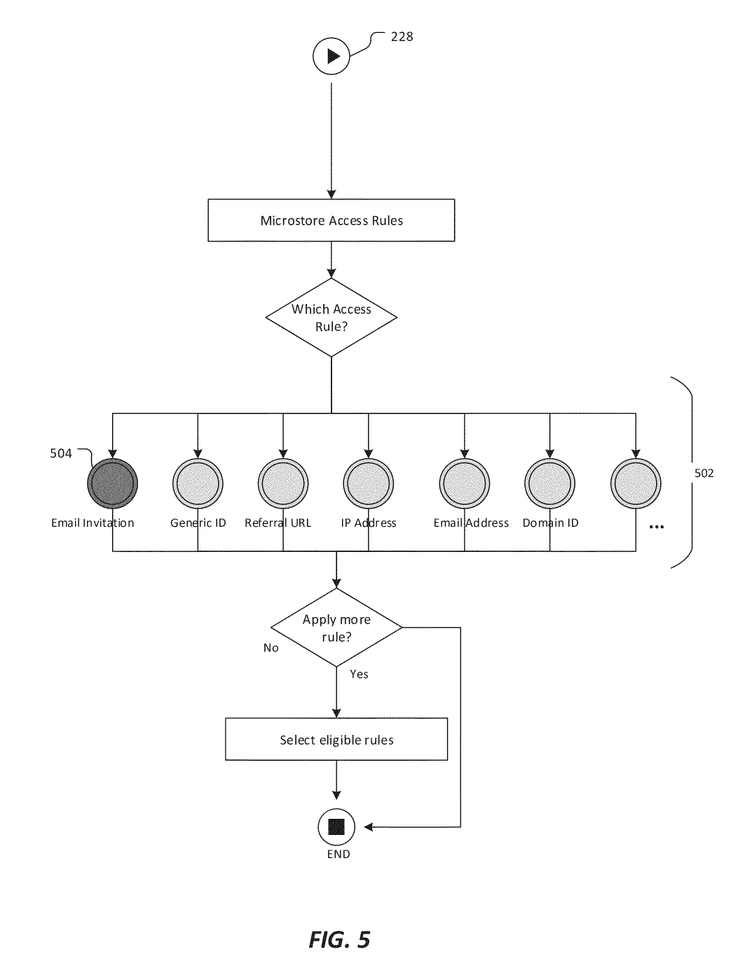

If the shopper matches an access rule defined for a microstore in the embodiment in FIG. 5, the resulting microstore is activated. From this microstore the resulting shopping experience is calculated from collecting data for explicit mappings, rules or configurations from each level as it traverses the hierarchical data model. The resulting intersection and or union of the configurations will be used to render the shopping experience to the shopper.

### Pricing Rules

Referring to FIG. 2, a seller may configure pricing rules to build Private Stores 204. The purchase plans are new pricing features that allow a seller to create a private shopping portal through which select shoppers can purchase products at a discount. Store Owners can create as many custom purchase portals as a seller to target specific shoppers and entice them to purchase from a seller's store. When setting a Private Store 210, a Private Store manager 1) can set discounts for each product in plan 212, 2) create a custom catalog of products that can be sold in plan 214, 3) can define purchase restrictions 218, 4) can set pricing and discounts for defined groups 220, and 5) can include capability to set product discounts 222.

Within a Store Owners main commerce site, a Private Store manager can implement multiple Private Stores 204 with specific product and pricing plans. Further, within Private Stores 204, multiple microstores 224 would be implemented having more restricted plans 228 with validation of rules 230 for selected product groups or customer segments.

A Private Store Manager can configure Private Store access rules to enable plan activating credentials, use presentation configuration to design, deploy and retire design elements such as banners and featured products on landing pages and applying themes to a Private Store. As shown in FIG. 3, seller's web site 103 has general catalog 302 including pricelist 304, and the storefront would be designed with themes and styles 306. This design would be used default theme or styles if none have been set within the Private Stores. A general store may contain one or more Private Stores. A Private Store is owned by the main ecommerce site. 103. It can sell all products, or a subset of products belonging to the main store, It can have its own storefront design/themes, and its own merchandising offers, A Private Store may contain-one or more microstores, which can be configured to display different offers, products, and themes.

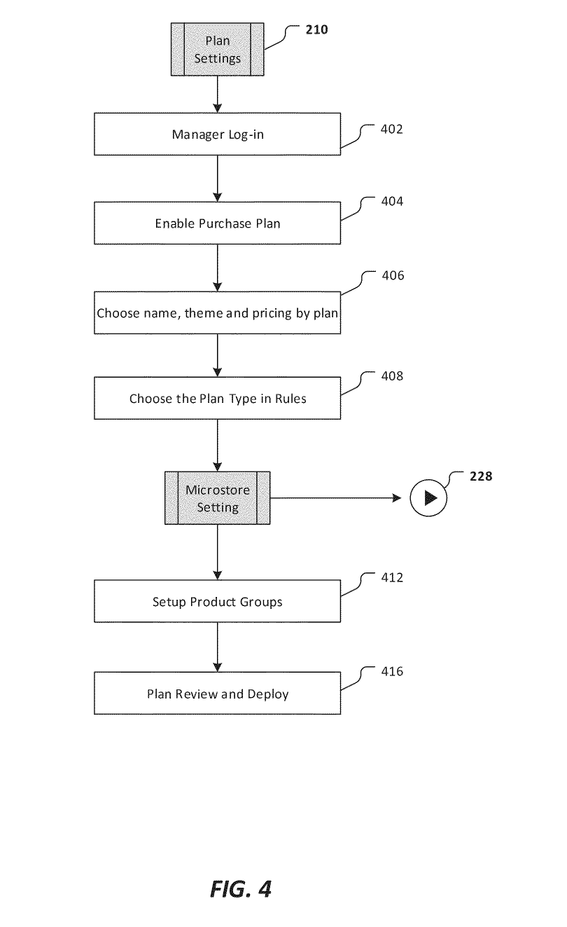

FIG. 4 is a block diagram illustrating the plan elements setting of Private Store. When a Private Store Manager log in a seller's website 402, Private Store manager can enable Private Store 404 in privileged administrative level. If Private Store function is enabled, Private Store manager can setup a purchase plan. As the first step of Private Store setup, a Private Store manager may name the plan, choose a design theme and apply pricing discount 406 if any. For example, if a plan manager would not set the theme for a Private Store, the Private Store would have default theme and style 306 in FIG. 3.

In this step 406, a plan manager sets the price for the Private Store-wide discount by percent off or amount off. A plan manager would pick the base price list to be used, and confirm the plan pricing compared with regular pricing for a seller's products. After setting-up general information for Private Store like name, theme and pricing 406, plan manager may choose plan type in rules 408. The plan may have two or more types in embodiment of the current invention. One would be “Standard” and the other would be “Friends and Family.” Depending on setting type of rules, Private Store may have options to choose for authenticating shoppers to permit access to Private Stores. Upon authenticating methods for shoppers, a Private Store manager would build one or more microstores 228.

On a Private Store attributes form, a Private Store manager sets up product groups 412. Each selected product group has its own attributes such as discount rates or activating dates in plan.

For Private Store setup, at the end of initial setup the plan, a Private Store manager can review the plan, save it and then deploy the plan 416. In reviewing the plan, a Private Store manager would set start and end dates of the plan. Further, a plan manager would modify or confirm for the plan. Once Private Store manager have reviewed the plan and deployed, the plan registered “deployed purchase plan” list. Later, Private Store manager may choose one of the deployed Private Store to add products to the plan.

### Product Groups

A Private Store manager can assign product groups 412 in FIG. 4 by a plan level or by a product group. A product group is a collection for products with either same discount and/or purchase restriction needs. As assigned product groups, customers can have different customized shopping experiences. Plan manager can restrict customers' shopping experience by life of plan or by dates and times. Further, in setting specific groups, a Private Store manager can assign pricing per groups. The plan manager would pick the products that will be discounted to the group. If the plan manager selected the products, only selected products would appear on the Private Store site at Private Store.

If a group discount is applied to the product, plan level discount 212 may override by product group discount 220 in FIG. 2. The group level discount also may be applied by percent off or amount off for each group. Further, the discount would support calculated and manually entered prices for each countries' currency.

Further, in the product group level, a plan manager also can restrict the quantity of products a shopper can buy at a discounted price in a given period of time. The restrictions can apply to individual products or across all products in a group. For example, if a shopper can buy a limit of two of each TV or a shopper can buy a limit of two TV's in a given period. The applied restrictions would be reset after a given time period, lifetime, month, quarter, year or custom. Also, line item restrictions can be used to set a minimum and maximum quantity at checkout time. For example, a plan manager can set limit of ten and line item of two. Then, a shopper would need five or more separate orders to reach maximum.

### Access Controls/Microstore

Referring to FIG. 5, a Private Store manager can choose type of plan by rules. The access rules are utilized by microstores. Microstores are a light weight mechanism to provide a differently branded store with the same or different products as the normal general store. Microstores may grant access to different groups of authorized users. Each microstore can be assigned a different theme and logo, or the same theme and logo can be shared across all microstores. The rules for granting access would be email address white list, email domain, generic identifier, referring URL, referring IP address and email invitation. Further, microstores may be individually branded and apply specific promotions per store.

When a Private Store manager selects the access rules for a plan, the options 502 presented may include email invitation, generic identifier, referral URL, IP address, email address, Domain ID, etc. These preceding items grant microstore access to shoppers who match the access rules in place. Further, microstores may have multiple authorization/access rules in place at once.

For example, a microstore URL Request first looks at the referring IP address and then the referring URL. If these do not match, a login page would be loaded. New account setup checks domain and email address to see if they match an access rule. Referring URL and referring IP address can be linked to email domain or address for additional security, both criteria must match in order for a shopper to gain access to the microstore. Referring URL and referring IP address will allow a shopper to browse a plan without creating an account. However, shopper account creation will be required at checkout time.

The generic identifier may be a single name and PIN used by each shopper. The generic identifier may be assigned and activated by a Private Store manager. These generic identifiers can be sent to anyone via email blast, etc. in order to use the purchase plan. The PIN is treated like a password and it can be used for anonymous checkout, where the customer doesn't have a password or account in the system.

Email address may be filtered by domain and sub-domain to accept emails addresses. This will be use the customer's password associated with that account if they've bought from the store before. Otherwise, customers have the option upon login to create an account. An email address may be used for corporate plans where people will have a common address.

IP address can be either a range of IP addresses or a single address. It is usually used for geographical regional plans. A Private Store manager may create a landing page by referral URL. If a shopper tries to access Private Store page directly, an error message may be displayed. If Private Store manager setup referral URL for access control, a shopper has to access through referral URL only.

### Friends and Family

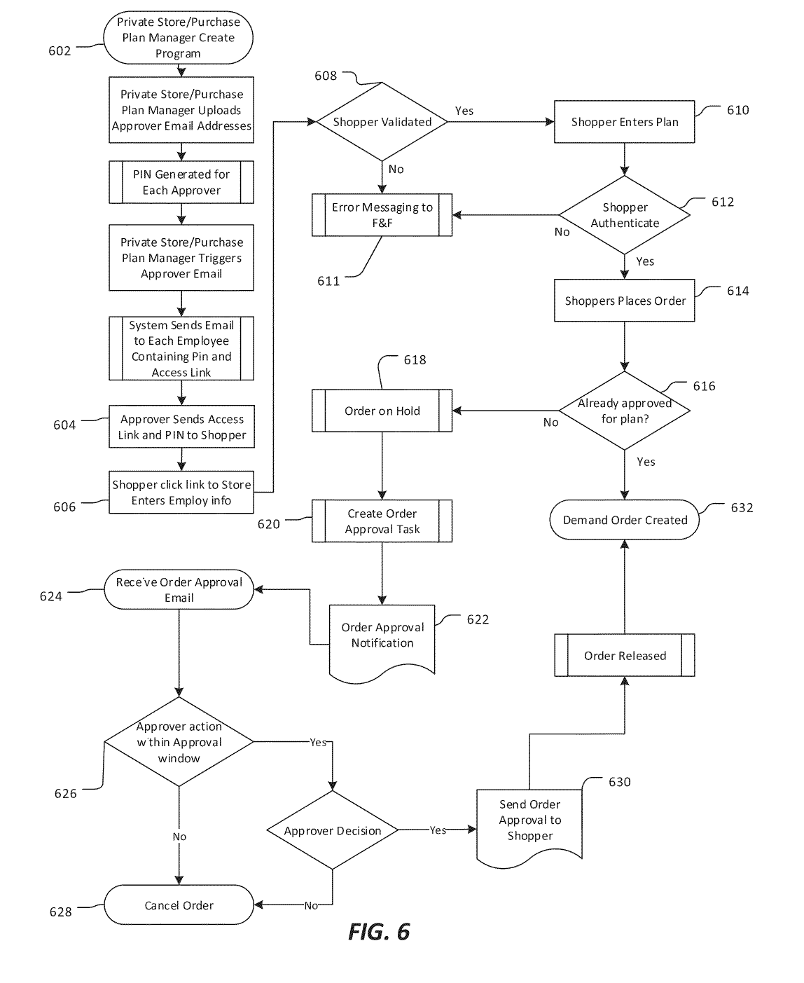

One embodiment of the present invention may include “Friends and Family” type plan. The Friends and Family plan is an invitation only plan, distinct one-to-one targeting capabilities extending marketing programs. To implement the Friends and Family plan, a purchase plan manager creates a Friends and Family program 602 in FIG. 6, by choosing authentication option 504 in FIG. 5.

Referring to FIG. 6, a private store/purchase plan administrator who wants to allow specific approvers to invite an individual or group of individuals can upload a list of approver email to the system 604.

Upon this upload of list of approvers to the system, the system generates a PIN for each approver 606. Once the system generates this PIN, it is made available to the private store/purchase plan administrator to trigger an email to the approvers 608 upload via the upload process outlined in 606.

Upon the private store/purchase plan administrator triggering this approver email 608, the system then will send an email to each approver containing a system PIN generated PIN and access link 610. Upon approver receipt of this system generated PIN and access link 610 the approver will send this system generated PIN and access link to their preferred shopper 612.

Once the preferred shopper receives the system generated PIN and access link provided by the approver 612, the preferred shopper will be able to click the provided access link to the private store 614 and enters validation information 614. The system then validates the information against the approver provided information 616. If the shopper provided information fails the system validation a system error message is triggered and sent to the preferred shopper 618.

If the preferred shopper information is validated successfully against the system 616, the shopper is able to enter the private store/purchase plan 620 for shopper authentication 622. If this shopper authentication fails a system notification is triggered and a system generated error notification is presented to the shopper 618. If the shopper authentication is successful 622 the shopper is then able to browse and plan an order 624.

Upon order placement, a system process will check for previous authentication 622 to determine if the user has been previously validated 626.

If the shopper has not been previously validated 626 the system will place the order in a hold state 628. The system will then create an order approval task 630. Once this system generated order approval task is created 630, the system will create an order approval notification 632 to be set to the order approver 634. Once this notification email 634 is sent to the necessary approver the approver must take approval action within a parameter based approval timeframe 636. The approver then has the ability to approve or deny this action 636. If the approver denies 640, or does not respond within the approval timeframe the shopper order will be automatically cancelled 638.

If the approver approves the order 640, upon approval a system generated notification of the order approval is sent to the shopper 642. Upon this system generated notification to the shopper 642 the system releases the shopper order 644. Upon the system order hold release 644 a demand order is created in the commerce system 646.

Software applications that reside on a server and are accessed by a client through a network are generally referred to as hosted application, and may also be referred to as Internet-based applications, web-based applications, or online applications. One of the embodiments of hosted applications may include ecommerce websites and web-based application. Customized pricing and restrictions have traditionally been applied at the end of a transaction, resulting in all shoppers sharing the same initial experience.

The individual components of the disclosed system and method are necessarily composed of a number of electronic components. Ecommerce systems are hosted on servers that are accessed by networked (e.g. internet) users through a web browser on a remote computing device. One of ordinary skill in the art will recognize that a “host” is a computer system that is accessed by a user, usually over cable or phone lines, while the user is working at a remote location. The system that contains the data is the host, while the computer at which the user sits is the remote computer. Software modules may be referred to as being “hosted” by a server. In other words, the modules are stored in memory for execution by a processor. The ecommerce software application generally comprises application programming interfaces, a commerce engine, services, third party services and solutions and merchant and partner integrations.

The application programming interfaces may include tools that are presented to a user for use in implementing and administering online stores and their functions, including, but not limited to, store building and set up, merchandising and product catalog (user is a store administrator or online merchant), or for purchasing items from an online store (user is a shopper). For example, end users may access the ecommerce system from a computer workstation or server, a desktop or laptop computer, a mobile device, or other electronic telecommunications or computing device. A commerce engine comprises a number of components required for online shopping, for example, customer accounts, orders, catalog, merchandizing, subscriptions, tax, payments, fraud, administration and reporting, credit processing, inventory and fulfillment. Services support the commerce engine and comprise one or more of the following: fraud, payments, and enterprise foundation services (social stream, wishlist, saved cart, entity, security, throttle and more). Third party services and solutions may be contracted with to provide specific services, such as address validation, payment providers, tax and financials. Merchant integrations may be comprised of merchant external systems (customer relationship management, financials, etc), sales feeds and reports and catalog and product feeds. Partner integrations may include fulfillment partners, merchant fulfillment systems, and warehouse and logistics providers. Any or all of these components may be used to support the various features of the disclosed system and method.

An electronic computing or telecommunications device, such as a laptop, tablet computer, smartphone, or other mobile computing device typically includes, among other things, a processor (central processing unit, or CPU), memory, a graphics chip, a secondary storage device, input and output devices, and possibly a display device, all of which may be interconnected using a system bus. Input and output may be manually performed on sub-components of the computer or device system such as a keyboard or disk drive, but may also be electronic communications between devices connected by a network, such as a wide area network (e.g. the Internet) or a local area network. The memory may include random access memory (RAM) or similar types of memory. Software applications, stored in the memory or secondary storage for execution by a processor are operatively configured to perform the operations in one embodiment of the system. The software applications may correspond with a single module or any number of modules. Modules of a computer system may be made from hardware, software, or a combination of the two. Generally, software modules are program code or instructions for controlling a computer processor to perform a particular method to implement the features or operations of the system. The modules may also be implemented using program products or a combination of software and specialized hardware components. In addition, the modules may be executed on multiple processors for processing a large number of transactions, if necessary or desired. Where performance is impacted, additional processing power may be provisioned quickly to support computing needs.

A secondary storage device may include a hard disk drive, floppy disk drive, CD-ROM drive, DVD-ROM drive, or other types of non-volatile data storage, and may correspond with the various equipment and modules shown in the figures. The secondary device could also be in the cloud. The processor may execute the software applications or programs either stored in memory or secondary storage or received from the Internet or other network. The input device may include any device for entering information into computer, such as a keyboard, joy-stick, cursor-control device, or touch-screen. The display device may include any type of device for presenting visual information such as, for example, a PC computer monitor, a laptop screen, a phone screen interface or flat-screen display. The output device may include any type of device for presenting a hard copy of information, such as a printer, and other types of output devices include speakers or any device for providing information in audio form.

Although the telecommunications device, computer, computing device or server has been described with various components, it should be noted that such a telecommunications device, computer, computing device or server can contain additional or different components and configurations. In addition, although aspects of an implementation consistent with the system disclosed are described as being stored in memory, these aspects can also be stored on or read from other types of computer program products or computer-readable media, such as secondary storage devices, including hard disks, floppy disks, or CD-ROM; a non-transitory carrier wave from the Internet or other network; or other forms of RAM or ROM. Furthermore, it should be recognized that computational resources can be distributed, and computing devices can be merchant or server computers. Merchant computers and devices (e.g.) are those used by end users to access information from a server over a network, such as the Internet. These devices can be a desktop PC or laptop computer, a standalone desktop, smart phone, smart TV, or any other type of computing device. Servers are understood to be those computing devices that provide services to other machines, and can be (but are not required to be) dedicated to hosting applications or content to be accessed by any number of merchant computers. Web servers, application servers and data storage servers may be hosted on the same or different machines. They may be located together or be distributed across locations. Operations may be performed from a single computing device or distributed across geographically or logically diverse locations.

Client computers, computing devices and telecommunications devices access features of the system described herein using Web Services and APIs. Web services are self-contained, modular business applications that have open, Internet-oriented, standards-based interfaces. According to W3C, the World Wide Web Consortium, a web service is a software system “designed to support interoperable machine-to-machine interaction over a network. It has an interface described in a machine-processable format (specifically web service definition language or WSDL). Other systems interact with the web service in a manner prescribed by its description using Simple Object Access Protocol (SOAP) messages, typically conveyed using hypertext transfer protocol (HTTP) or hypertext transfer protocol secure (HTTPS) with an Extensible Markup Language (XML) serialization in conjunction with other web-related standards.” Web services are similar to components that can be integrated into more complex distributed applications.

It is to be understood that even though numerous characteristics and advantages of various embodiments of the present invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application, while maintaining substantially the same functionality without departing from the scope and spirit of the present invention.

1. A computerized method comprising:
building and managing purchase plan for each online stores;
building design of ecommerce online store for customizing shopping experience;
providing access control to restricted group of shoppers;
managing products lists to apply special price;
producing invitation-only shopping process;

2. The computerized method of claim 1 providing a portal for creating online stores for specific targeted shoppers by setting the plurality of private stores associated with the purchase plan.

3. The computerized method of claim 1 wherein providing access control to online stores by using a plurality of authentication rules for a plurality of shopper segmentations.

4. The computerized method of claim 1 wherein building online store design for the completed purchase plan based on products and shopper segments, and the relationship between stores includes the plurality of prices of the products.

5. The computerized method of claim 1 wherein providing product relationship data model includes a plurality of product and hierarchical structure to implement multiple tiers.

6. The computerized method of claim 1 generating a plurality of rule sets associate with each authorization rules to manage.

7. The computerized method of claim 1 wherein providing product relationship data model provides product-specific purchase rules including restrict or permit certain types of shopper segmentations.

8. An e-commerce computer system comprising:
a purchase planning module for managing and storing relationships between a plurality of products with at least one shopper segment and store design;
an access rules module for limiting access to online private stores associate with the purchase plans, the access rules module producing an authentication or authorization rules indication upon completion of access rule list;
a pricing module that receives selected products lists of the private store and sets up discount rates by amount or percentage of the original prices; and
a portal for communicating with at least one specific price and product associated with a purchase plan, the purchase planning module outputting a result from the communicating with pricing and access rules modules associated with the purchase plan.

9. The e-commerce computer system of claim 8 wherein:
building hierarchical data model implementing multiple private stores for entities to define access rules in each microstores;
building mapping data model that setting up the individual or group products based on specific discounted price;
building mapping data model between private stores under the nature of specific purchase plan, and between private stores and microstores under the type of access rules; and
building hierarchical data model implementing multiple microstores for entities to define access rules.

10. The e-commerce computer system of claim 8 wherein:
generating access rule list that a set of attribution identifiers to control access to private store and its discounted products list;
generating product lists that a set of product to apply each discount prices created by storeowners;
generating emails messages to send invitations to targeted shoppers and to send messages to confirm purchasing by targeted shoppers;
storing and distributing access rules during commerce transaction by shoppers;
building mapping data model between prices and shoppers' attribution;
tracking a plurality of events based on purchasing type and shoppers; and
triggering executable computerized program associated with purchasing transaction.

11. The e-commerce computer system of claim 8 wherein
employing to provide at least a portion of pricing list associate with products;
receiving at least a plurality set of products information corresponding to the shopper segmentations;
generating and storing a plurality of web designs as a plurality of themes;
mapping a plurality of themes associated with the online stores characteristics;
changing or appending variables to original web URL to redirect parties to co-branding web sites:

12. The e-commerce computer system of claim 8 further comprising:
a processor;
a memory coupled with the processor, wherein the purchasing planning module, the access rules module, and the pricing module operate on the processor using the memory;
a network communication device configured to exchange data communications through a communication network; and
a storage device accessible to the processor.

13. A machine-readable medium providing instructions that, when executed by a machine, cause the machine to perform operations comprising:
managing and storing purchase plans for a plurality of stores, the stores including at least a product lists and an access rule within microstores; and
tracking at least one purchasing activity associate with the shopper;
providing access controls to restricted group of shoppers;
building and managing product lists applying to at least one private store or one product group; and
producing messages for invitation-only shopping process.

14. The machine-readable medium of claim 13 further comprising an instruction that causes the machine to generate, collect, store, and distribute a plurality of commercial transaction for a plurality of shopper segmentations.

15. The machine-readable medium of claim 13 wherein the managing and storing relationships between a pluralities of products using hierarchical data model to generate multiple relationship among private stores.
